(19) United States
(12) Patent Application Publication
(10) Pub. No.: US 2004/0264722 A1
(43) Pub. Date: Dec. 30, 2004

(54) Locking mechanism for electronics module for hearing instruments

(76) Inventor: Martin W. Masters, Hillsborough, NJ (US)

Correspondence Address: Alexander J. Burke, Intellectual Property Department, 5th Floor, 170 Wood Avenue South, Iselin, NJ, 08830, US

(21) Appl. No.: 10/608,705

(22) Filed: Jun. 27, 2003

(51) Int. Cl. H04R 25/00

(52) U.S. Cl. 381/322; 381/324

(57) ABSTRACT

A force opposing tab on the peripheral surface of an electronics module will prevent inadvertent dislodging of the module from the hearing instrument housing when force is applied the battery door.

### BACKGROUND OF THE INVENTION

Various electrical components of a hearing instrument can be situated on a module that plugs into an opening in the housing of the instrument. The module has latches protruding from the bottom of the module that mate with the housing. A door on the module permits access to a battery.

To remove the hearing instrument from the user's ear, the opened door may be used as a handle. The force applied to the door to achieve removal may be of such magnitude that the latches slip off the mating surfaces, dislodging the module from the hearing instrument housing. To prevent this from happening, a tab may be provided on the module near where the door attaches to a hinge on the module. When the module is inserted into the opening of the housing, the tab slips under the surface of the opening and the latches snap into place. The tab opposes the force applied to the battery door, assuring that the module will remain in place.

### BRIEF DESCRIPTION OF THE DRAWINGS

FIGS. 1 and 2 are drawings of a hearing instrument module with a battery door;

FIGS. 3-6 are perspective views of the module of FIGS. 1 and 2 inserted in the opening of a hearing instrument housing; and

FIGS. 7 and 8 are drawings of the module of FIGS. 1-6.

### DESCRIPTION OF THE INVENTION

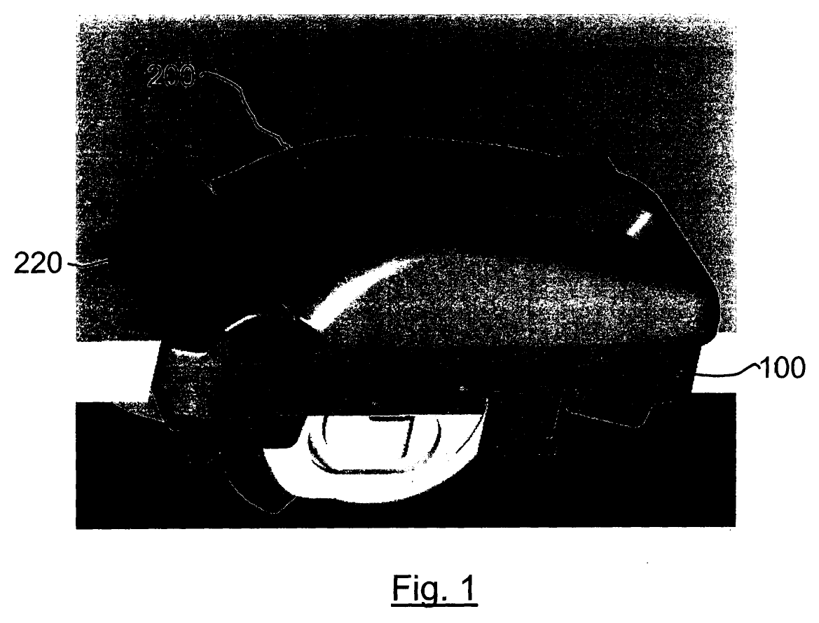

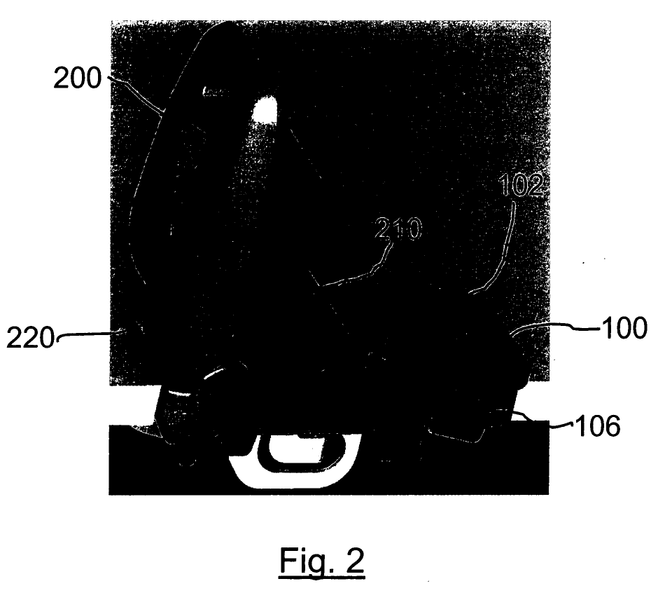

FIGS. 1 and 2 illustrate an electronics module 100 for a hearing instrument. The module 100 has an upper surface 102 on which there is a door 200 with a holder 210 for a battery (not shown) attached to the module 100 at a hinge 220.

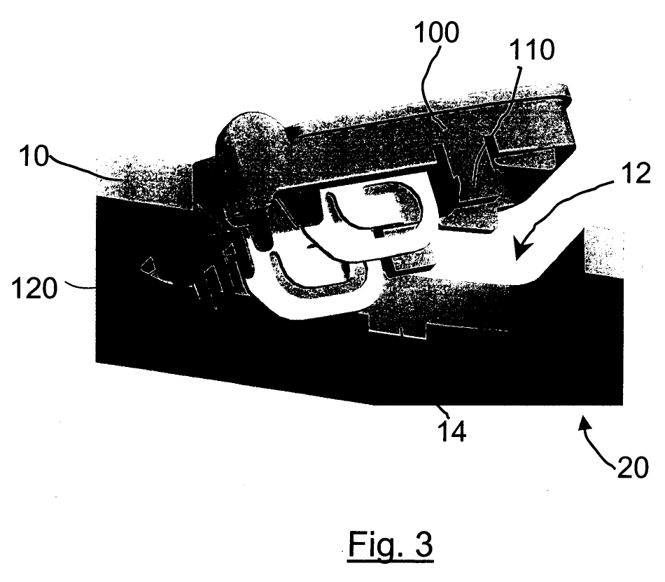

As can be seen in FIG. 3, the module 100 is inserted into an opening 12 in the hearing instrument housing 10. The shape of the opening 12 conforms to the peripheral surface 106 of the module 100. Latches 110 on the module 100 mate with protrusions 14 on the inside surface 20 of the hearing instrument housing 10 and serve to keep the module 100 in place after insertion in the opening 12. However, notwithstanding the presence of the latches 110, a significant amount of force may be applied to the door 200 when it is used to assist in removal of the hearing instrument from the user's ear that could result in dislodging the module 100 from the hearing instrument housing 10.

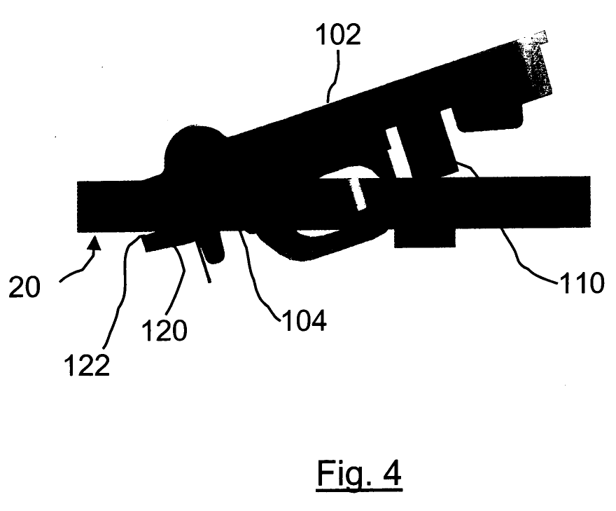

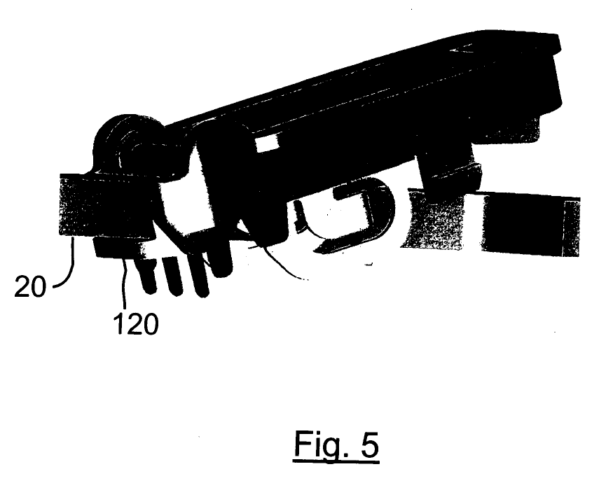

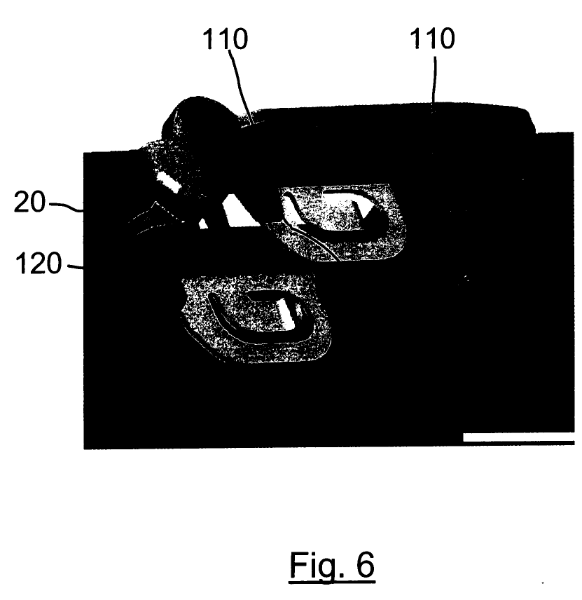

To prevent an inadvertent dislodging of the module 100 when force is applied to the door 200, a tab 120 is provided on the lower surface or underside 104 of the module 100 near the hinge 220 (see FIGS. 4 and 8). The tab 120 protrudes outwardly from the module 100 in a perpendicular direction with respect to the peripheral surface 106 of the module 100. The module 100 is inserted into the opening 12 at an angle to permit the tab 120 to slip under the inside surface 20 of the housing 10 (see FIGS. 3-5) and the latches 110 then slip into place (see FIG. 6).

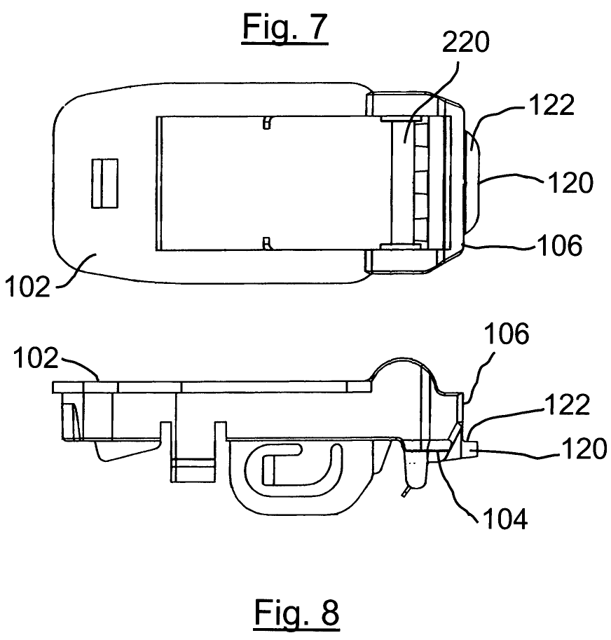

When the module 100 is seated in the opening 12, the top or upper surface 122 of the tab 120 is adjacent and parallel to the inside surface 20 of the housing 10. When the door 200 is opened, the force applied to the door 200 is also applied through the module 100 to the upper surface 122 of the tab 120 in opposition to the immediately-abutting inside surface 20 of the hearing instrument housing 10. The depth (the horizontal dimension in FIG. 7) and width (the vertical dimension in FIG. 7) of the upper surface 122 are selected to provide adequate surface area for opposing the force applied by when the battery door is opened.

What is claimed is:

1. A hearing instrument, comprising:
a housing, the housing comprising an opening for an electronics module and an inside surface; and
an electronics module for insertion into the opening of the hearing instrument housing, comprising:
upper and lower surfaces;
a peripheral surface, between the upper and lower surfaces, conforming to the opening in the housing;
a door and hinge; and
a tab in the vicinity of the hinge, protruding outwardly from the module with respect to the peripheral surface.

2. A hearing instrument as set forth in claim 1, where the tab is located on the on the lower surface of the module and comprises an upper surface parallel to and adjacent the inner surface of the housing when the module is seated in the opening of the housing.

3. A module for insertion into an opening in a hearing instrument housing, where the housing comprises an inside surface, comprising:
upper and lower surfaces;
a peripheral surface, between the upper and lower surfaces, conforming to the opening in the housing;
a door and hinge; and
a tab in the vicinity of the hinge, protruding outwardly from the module with respect to the peripheral surface.

4. A module as set forth in claim 3, where the tab is located on the lower surface of the module and comprises an upper surface parallel to and adjacent the inner surface of the housing when the module is seated in the opening of the housing.

5. A module as set forth in claim 4, where the upper surface of the tab opposes the inside surface of the hearing instrument housing.

6. A force-opposing tab for a hearing instrument module residing in an opening in a hearing instrument housing, where
the housing comprises an inside surface, and
the module comprises upper and lower surfaces, a peripheral surface, between the upper and lower surfaces, conforming to the opening in the housing, and a door and hinge;
the tab comprising:
a member, in the vicinity of the hinge, protruding outwardly from the module with respect to the peripheral surface.

7. A force-opposing tab as set forth in claim 6, where the member is located on the lower surface of the module and comprises an upper surface parallel to and adjacent the inner surface of the housing when the module is seated in the opening of the housing.
